(19) United States
(12) Patent Application Publication
(10) Pub. No.: US 2014/0289518 A1
(43) Pub. Date: Sep. 25, 2014

(54) Method and Apparatus for Privately and Securely Sharing Information Using Public Social or Sharing Network Infrastructure

(71) Applicant: Tuhin Sinha, San Francisco, CA (US)

(72) Inventor: Tuhin Sinha, San Francisco, CA (US)

(21) Appl. No.: 14/216,479

(22) Filed: Mar. 17, 2014

Related U.S. Application Data
(60) Provisional application No. 61/798,921, filed on Mar. 15, 2013.

(51) Int. Cl. G06F 21/62

(52) U.S. Cl. CPC G06F 21/6209
USPC 713/165

(57) ABSTRACT

A method of securely storing and sharing information through social networking websites is disclosed. The method makes it possible to proscribe image data that retains information even through the JPEG compression process typically used in social networking sites. This embedding technique is coupled with encryption and information salting techniques to build a robust information encoding technique to store arbitrary, sensitive data in images. The invention further incorporates methods of permitting advertising through the information sharing process.

### CROSS-REFERENCE TO RELATED APPLICATION

This application claims the benefit of U.S. Provisional Application No. 61/798/921, filed Nov. 5, 2012.

### FIELD OF THE INVENTION

The present invention relates generally to methods of storing and sharing information in a secure, digital format utilizing existing infrastructure in the form of social networking sites such that access to the information is limited to selected recipients.

### BACKGROUND OF THE INVENTION

Social networking, since its inception, has rapidly become one of the main modes of communication between individuals, and groups. Social networking and/or social networks are intended to he interpreted broadly and to be defined as a social structure made up of individuals (or organizations) called, for example, “nodes”, which can be tied (e.g., connected) by one or more specific types of interdependencies, such as, friendship, kinship, common interests, financial exchanges, dislikes, likes, relationships of beliefs, knowledge, prestige, etc. Web-based social networking services, for example, Facebook, Twitter, MySpace, Bebo, LinkedIn, Xing, etc., make it possible to connect people who share interests and activities across political, economic, and geographic borders. Social networks (hereinafter including web-based social networks) provide a new way for individuals to communicate digitally.

The ease of digital communication using social networks has been offset by the increasing feelings of insecurity and mistrust as to misuse of the information that individuals share over a social networking. The rapid commercialization of sites like Facebook, depends on two conflicting goals. First, such social networking sites must offer an easy and secure way for their users to communicate with one another, thus encouraging those users to share their personal information and life stories with one another to form communities of users. Second, the social network operators must generate revenue in order to support the very infrastructure which provides the social networking services. Some social networks have charged a fee in order to generate the needed revenue, but the vast majority have relied on the paid for advertising model, with the promise of selectively target advertising. Such advertising is targeted to specific users based on that same user's disclosures of information, such as hobbies or favored activities. This business model has left the average social networking user torn between a desire to share more with their social networks, and conversely, a desire to retain rather than share in order to avoid being targeted with advertisements based on those same disclosures.

While many social network sites have attempted to allay their users' fears by implementing certain privacy setting, or “opt out” methods, this generates two problems. First, allowing users to do so destroys the very source of revenue upon which most social networking sites depend on. Second, given the frequent and oftentimes unilateral changes in privacy policies of various social networking sites, users often feel as if their personal data on such sites is no longer under their control in any way other than illusory.

In today's era of big business data mining and ever changing privacy policies, social network members desire a simple way to securely and privately share data with select members using the existing social networking infrastructure that they are already familiar with, but without having to worry about their private information being delivered into the hands of others, misused, or sold for commercial purposes.

### SUMMARY OF THE INVENTION

This invention relates to secure storage and sharing of information using existing social networking sites with information sharing and data storage capabilities. The invention is novel in that it accounts for data loss in the image posting processes associated with major social networking sites.

The invention provides a compelling solution to permit the secure use of a social network for information sharing and aggregation. To date social networks such as Facebook have been used largely for non-technical information storage and distribution. One unmet need on Facebook, and other social networks, platform is a refined approach to handling sensitive data. An object of the invention is to maintain many of the benefits of social networking sites, such as the ease of storing and sharing information, while avoiding many of the drawbacks related to social networks, such as data mining and public disclosure of private and sensitive information.

A technology which addresses this need in a new and innovative way is disclosed herein. The disclosed innovative system builds on steganographic approaches used historically to “hide” information in images. A challenge that social networks face with regard to traditional steganographic methods is that each image, when uploaded to, for example, Facebook, undergoes JPEG image compression. This process results in destructive data loss, which prevents naive embedding systems from being able to reconstruct the encoded information.

The disclosed invention implements a custom steganographic technique to allow information encoding in any digital image for use on social networking websites, where the image upload process may incur lossy image processing (such as compression). This technique solves a very compelling problem in the current use of large public social networking systems, in that information stored on these systems is unilaterally controlled by a single entity. The technique divorces the encoded data from the decoding key and stores each of those separately (i.e. the encoded image is stored on, for example, Facebook, while the decoding key is stored on self-managed servers). Only when authorized users (read: the owners of the data) authorize the decryption. Thus, no single party is capable of mining the sensitive information without active participation by the original owner of the data.

The inventive technique absolves any one party from the responsibility of holding the complete data, by separating the key and encrypted information across two separate entities. For example, the encrypted and encoded image data is stored on the SNS, while the decoding and decryption information may be stored on an independent platform (which may or may not be the encoding system). In the simple case the encoding/embedding system also stores the key and the SNS stores the encoded data, and the original data would only be reconstructed if the key and encoded data were reconnected via SNS sharing mechanisms.

This technique can be extended to allow a primary SNS (or cloud data storage service) to store the encoded information and a secondary SNS to store the key. Implementing this technique, both networks sharing mechanisms could be leveraged to provide highly nuanced decode authorization schemes. For example, the key on an SNS as an image that can be “tagged” while the encoded data cloud be stored on a “cloud drive” that allows for sharing of folders. In this example, only users who were both tagged in the primary SNS, and also in the shared drive on the secondary SNS would be authorized to decode the information.

In one embodiment, the invention encodes data into an image. As an initial step, the invention combines an input image and a background image in a novel implementation that compensates for loss in JPEG compression. The loss compensated image is then uploaded to a social network or other online service that performs lossy compression (or other image degrading process). The encrypted data is then housed solely by the third party social network or other online service. In this example the encoded message is allowed to be decoded by those “tagged” in the image.

The disclosed invention facilitates leveraging third-party SNSs and their sharing systems as access control lists for asymmetric encryption key management. By leveraging existing sharing workflows, the invention allows for simplified encryption key distribution and revocation. For example, this allows the inventive technology and systems to leverage online cloud storage systems and their concepts for shared folders to provide simplified distribution and authorization of keys which can then decode encrypted contents of the items stored in those shared folders, without the need for sharing passwords, passcodes, or other credentials. Further, this concept extends to sharing mechanisms such as re-tweets (on the SNS Twitter), and also email via forwards or carbon-copied (CC'ed) entails.

Further, the inventive technology permits the simple distribution (or key management) through third-party sharing protocols for data encapsulations other than 2D images, including but not limited to encrypted video, links, or comments. For example, a video could be shared/authorized by “at-mentioning” a user (prefixing a username with an ‘@’ symbol) in a comments feed on the post. Similarly, groups of followers for a given hashtag (categorizations prefixed with the ‘#’ symbol) in a comments feed could also be authorized to decode the original post.

### DETAILED DESCRIPTION

The inventive technique was developed after careful investigation of the JPEG image encoding and decoding process for data loss. Briefly, during encoding, the JPEG process reduces data within an image in two distinct phases, which are repeated in reverse to reconstruct an image from JPEG encoded information. The first step in the encoding phase is a floating-point calculation of the Discrete Cosine Transform (DCT) coefficients for independent, non-overlapping, 8×8 pixel blocks in the image. The DCT coefficients undergo dynamic range reduction by dividing each coefficient by a pre-defined quantization matrix. After division, the reduced DCT coefficients are rounded to the nearest integer, and this represents a step where information may be lost permanently. This reduction process generates a number of zero-elements in the DCT matrix which are compressed using Huffman lossless encoding.

The invention was developed by examining the qualities of the JPEG compression process that allow maximum preservation of the coefficients. Once these qualities were determined, by empirical analysis, it is possible to proscribe image data that retains information even through the JPEG compression process. This embedding technique is coupled with AES-256 bit encryption and information salting techniques to build a robust information encoding technique to store arbitrary, sensitive data in images.

In one embodiment, the inventive compression process leverages key characteristics of the direct-cosine transform (DCT) used in the standard JPEG compression process. For lossless implementation, the JPEG quantization table Q (in [1]) for the third-party SNS site is determined empirically. Once determined, a DCT table G is created, such that the quantization process provides the quantized DCT coefficients that represent the encrypted information in the final JPEG image, (e.g. B in [1]). Once G is determined, a composite three-color (red-green-blue) input image may be back calculated by reversing the colorspace conversion form luminance-chroma space (YCbCr) to red-green-blue colorspace, using G as the luminance (Y) channel, and artificially clamping either Cb or Cr to reproduce red, green and blue values within an 8-bit dynamic range (0,255).

The result of this process produces a full dynamic range three-color image that accurately renders the encrypted information as quantized DCT coefficients after going through the JPEG compression process.

In the event that the floating point calculations on third-party sites create variations in the quantization process (B=round(G/Q)), predicted coefficients from those created by the third-party site can be confirmed. Where there are discrepancies, caused by floating point precision, coefficient discrepancies may he captured and stored as a sparse error correction vector that can be applied subsequently to the retrieved DCT coefficients from REG images from the third-party SNS.

With this powerful new embedding technique, and coupling, with the capabilities of social networking platforms a novel information storage and sharing mechanism arises, which has been unavailable to date: the ability to securely store information in a chronological context timeline) and in-tune with de facto social network sharing mechanisms (likes, tags, etc.).

The inventive method of data decoding utilizes existing paradigms on the target (host) social networking site. For example, on Facebook, this may he the owner of the image object that has been submitted for decoding. If the request submitter is equivalent to the owner (as defined by who encoded the original data) of the image then the inventive algorithm proceeds with the information reconstruction and decryption process. A similar example includes the use of tags (which can represent other users, message responses, or keywords), where if the owner of an embedded tag is also allowed to decode the data.

A preferred embodiment of the invention which utilizes Facebook to share electronic health records, such as immunization records. In this embodiment, the user uploads personal health information to a computational system, where the data are encrypted and encoded into a background (carrier) image. The inventive technology compensates for data loss that occurs with JPEG compression, which allows reading and decoding of the images stored on Facebook at a later date.

The computational system stores the decryption and decoding keys, and pushes the encrypted/encoded image to the user's Facebook account. At this point the original data does not exist in any single location on the Internet. The only way to recreate the original data is to use the encoded data on Facebook along with the decoding key.

To bring these two data pieces together, the invention leverages the well-known data sharing models on Facebook that are well understood by its end-users. In this case, the “tag” mechanism on Facebook is used as the authorization key for decoding. That is, only other users that are tagged in the encoded photo, are authorized to decode the data.

For each encoded post on Facebook, a caption is added that contains a custom decode link, which resolves to a specific request to a server. To perform the decoding, servers then query Facebook for information in its database regarding who owns the encoded image and who is tagged in the encoded post. If, and only it the person requesting to see the decoded information is either the owner or is tagged in the post, the decoding process will be performed.

Furthermore, the decoded data is volatile, in that it is stored only in memory and is lost when the user browses away from the decode screen or closes their browser.

In another embodiment, this technology may be used to communicate education related information, including test scores, report cards, transcripts, admissions results, and confidential educational assessments. In another embodiment, this technology may be used also by childcare personnel to communicate childcare status and updates to parents on social networking sites, as well as it regarding injury or illness events. In another embodiment, this technology can be used to transfer documents including architectural drawings or other schematics and/or blueprints. The information could be used in the architectural industry to securely share diagrams with clients on social networking sites. In another embodiment, this technology can be used by financial services companies to provide account statements, balances, invoices, stock or securities transactions, prospectus, earnings statements and/or investor relations materials. In another embodiment, this technology can be used to transmit tickets or other single-use documents, such as airline tickets, concert tickets, itineraries, hotel accommodations, travel documents, and/or passport/visa information

In summary the inventive method accounts for and proscribes image pixel values such that any lossy encoding process on a social networking site is accounted for. This allows for the ability to encode custom information in a steganographic fashion into template images. The invention then utilizes the social networking site's native sharing paradigms to allow data sharing and decoding credentials. The inventive method allows for a novel way to share arbitrary data via social networking sites and also provides additional data privacy by divorcing the storage of sensitive data across multiple responsible parties. The inventive technology provides a new, compelling, and empowering system for end-users of social networking sites, to encode, track, share, and store sensitive and personal information on otherwise public and invasive social networking sites.

### BRIEF DESCRIPTION OF THE DRAWINGS

Embodiments of the invention will now be described, by way of example, with reference to the accompanying drawings, wherein:

FIG. 1 discloses an example of the encoding process of the invention in the form of a flowchart. An input image and background image are combined in a novel implementation, e.g. overcompensation that aims to compensate for loss in JPEG compression. The loss compensated image is then uploaded to a social network or other online service that performs lossy compression (or other image degrading process that may, for example, remove overcompensation). The encrypted data is then housed solely by the third party social network or other online service.

FIG. 2 discloses an example of social network specific decode authorization scheme. In this example the encoded message is allowed to he decoded by those “tagged” in the image. The users “E B” and “D F P” are allowed to decode the embedded data, in this case.

FIG. 3 discloses a schematic of an example of the decoding process. Here the authorized user's credentials are used to retrieve the image from the third party social network site. The decoding key from the application is then also provided to the authorized user and the decoding/decrypting process is performed. The resultant data is the represented to the end-user.

FIG. 4 provides an example chronological view of encoded data. A variety of encoded data are shown, integrated into a singular view. The power of this technique is that a cohesive interaction can be implemented for a variety of data types. For example, health data, advertisement data and image data are all incorporated on a single chronological “timeline” view.

FIG. 5 depicts an example application of the technique to embed authorized advertisements in encoded images. This technique can be used to drive exclusive deals or offers to consumers. The decode authorization can be provided through any sharing mechanism provided by the social networking site or online service.

FIG. 6 depicts an example of providing semi-transparent overlay data onto the encoded images. In this example a banner advertisement is placed along the bottom of the image. This method can be used to apply custom branding and watermarking to any background image and could be used to drive custom feedback or messaging for the encoded messages.

FIG. 7 demonstrates an application for the encoded data in storing personal health information. Here, the person's entire medical record data is stored in a secure fashion in the image. This encoded image can then be shared and curated on a social network or other online tool. Further the time-specific information (doctor visits, prescriptions, immunization, etc.) can be stored in chronological fashion in a timeline view.

### DETAILED DESCRIPTION OF THE DRAWINGS

The following description provides details with reference to the accompanying drawings. It should be understood that the invention may be embodied in many different forms and should not be construed as limited to the embodiments set forth herein.

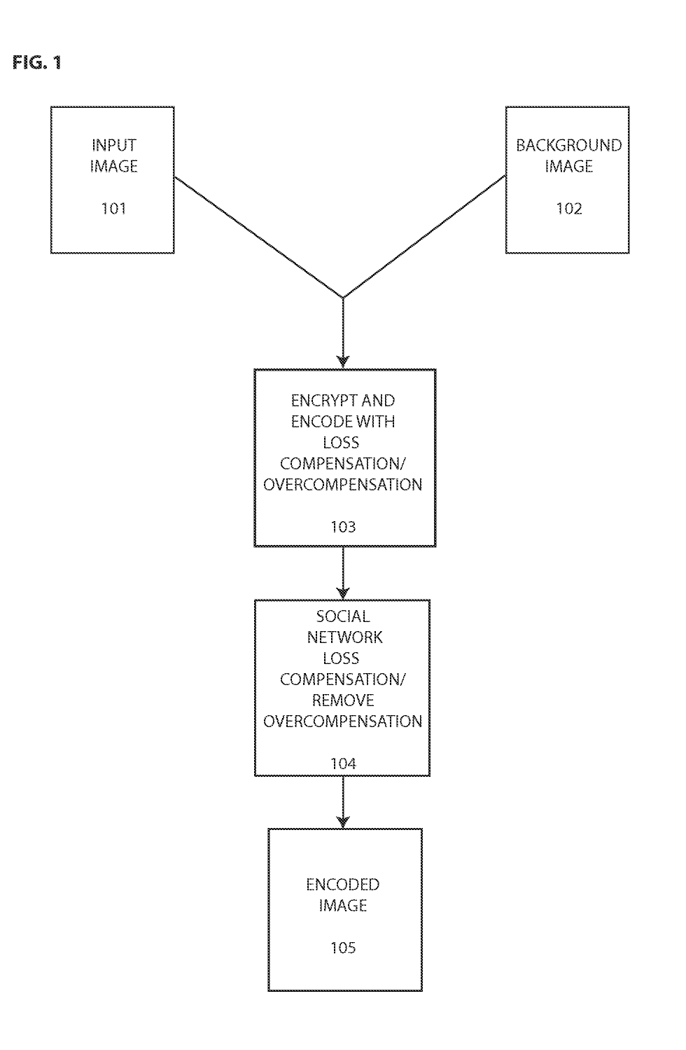

FIG. 1 shows the encryption & encoding process with loss compensation. An input image 101 and a background image 102 are encrypted and encoded with loss compensation/overcompensation 103 to create an encoded image 105. The encoded image 105 is then uploaded to a remote server such as a social network with lossy compression 104. Although the remote server discussed herein is a social network server such as Facebook, those of skill in the art will recognize that the remote server may be any number of types of remote servers.

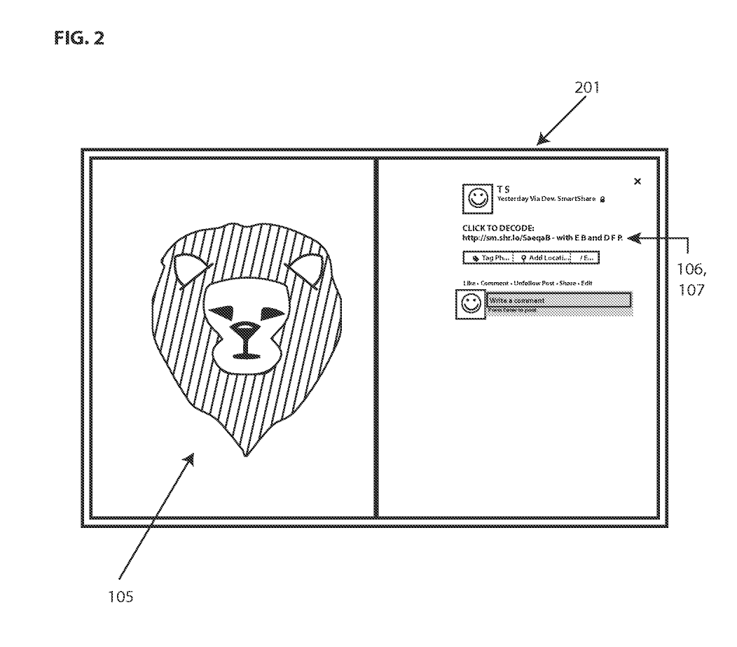

FIG. 2 shows an exemplar display 201 of the encoded image 105 as hosted on a social networking 104 including authorization tags 106 and 107 which allows those tagged users to decode the posting.

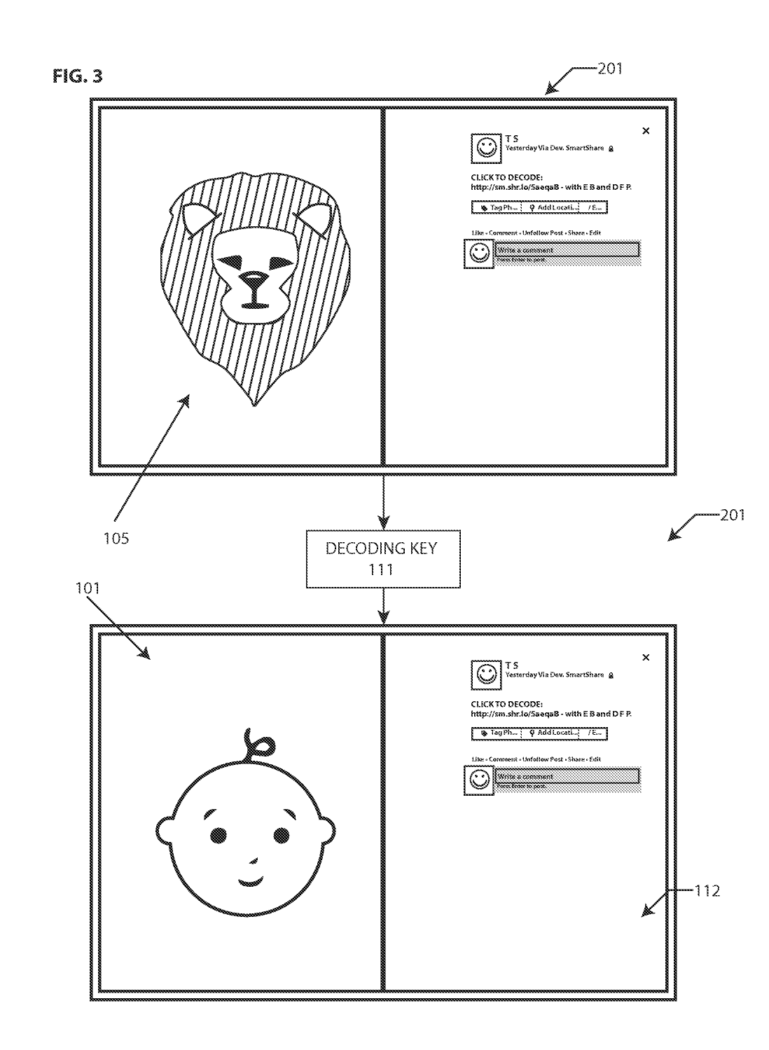

FIG. 3 demonstrates how the encoded image 105 is decoded using the decoding key 111. The result of which displays the input image 101 in the users social network page 112.

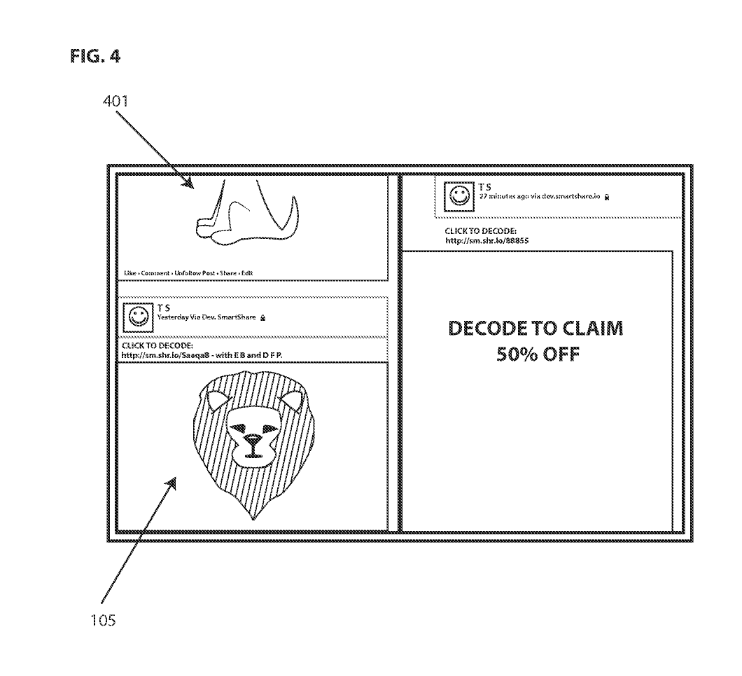

FIG. 4 shows how a series of encoded images 105 are displayed on a user's Facebook timeline 401. Although the timeline feature of Facebook is used as an exemplar, those of skill in the art will recognize that any number of social network features can be used.

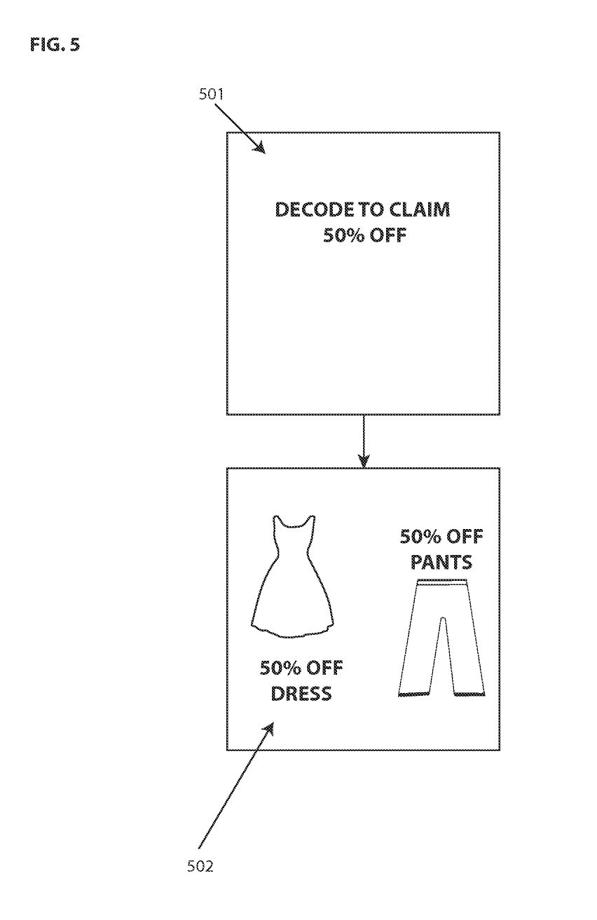

FIG. 5 demonstrates how advertisers can embed input images 502 containing special offers in the encoded image 501. Decoding rights to the special offer embedded image 502 can be transmitted by a variety of means, including tags, shares, likes, mentions, or other methods.

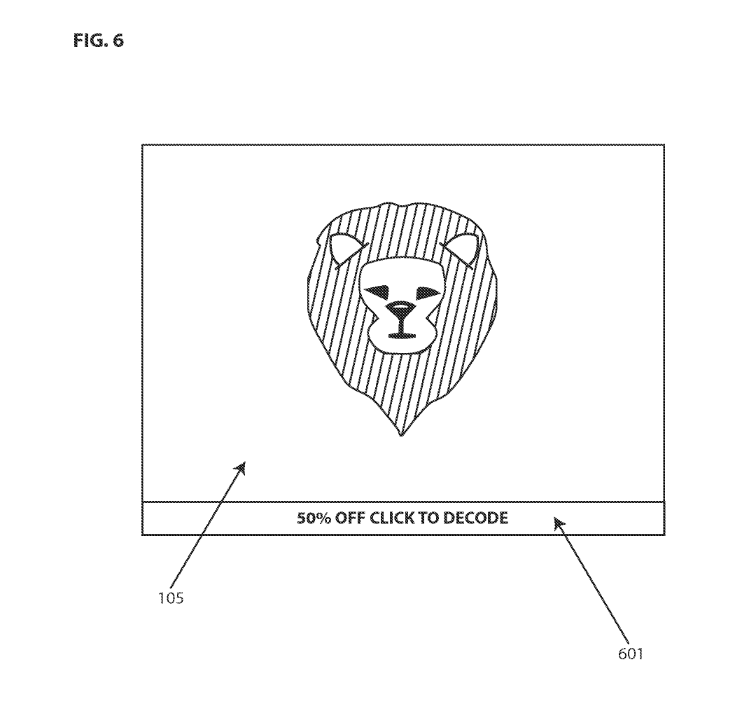

FIG. 6 depicts how advertisers can take advantage of the encoded image 105 by including digital watermarks containing advertisements 601.

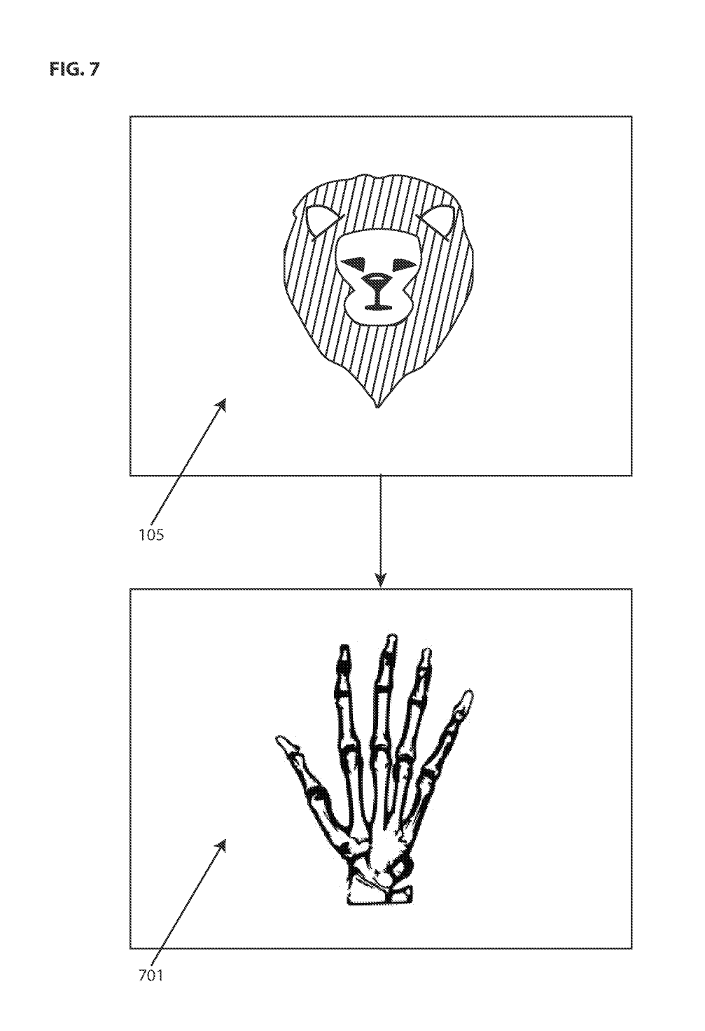

FIG. 7 demonstrates how information other than an input image can be contained through the use of the embedded image 105, such as health record information 701.

What is claimed is:

1. A method for storing and sharing data in a way that requires multiple points of failure and prevents anonymous data mining comprising:
a) Creating an encrypted data file capable of being uploaded to a third-party platform;
b) Creating a decoding key capable of decrypting the encrypted data file;
c) Maintaining the decoding key separately from the encrypted data tile such that the source of the decoding key has no knowledge of which decoding keys are associated with which encrypted data files; and
d) Embedding specific URL's on the third-party platform to connect the decoding key and the encrypted file.

2. The method of claim 1 wherein the encrypted data file is created using loss compensation.

3. The method of claim 1 wherein the decoding key is stored on a self-managed server.

4. The method of claim 1 wherein embedding the specific URL is accomplished through the use of social network sharing mechanisms.

5. The method of claim 1 wherein the embedded URL is used to authorize decryption of the encrypted file.

6. A method for embedding source information on a third-party platform that allows for 2-D image sharing comprising:
a) Creating an encrypted data file capable of being uploaded to a third-party platform and capable of undergoing loss compensation on the third-party platform;
b) Creating a decoding key capable of decrypting the encrypted data file;
c) Maintaining the decoding key separately from the encrypted data file such that the source of the decoding key has no knowledge of which decoding keys are associated with which encrypted data files; and
d) Overlaying decoding key access controls to the encrypted data file though the third-party platform's existing application program interface.

7. The method of claim 6 wherein the encrypted date file may include any arbitrary source information.

8. The method of claim 6 wherein the embedding and decoding are achieved without any medication of the third-party platform.

9. A system for storing. and sharing data in a way that requires multiple points of failure and prevents anonymous data mining comprising:
e) Creating an encrypted data file capable of being uploaded to a third-party platform;
f) Creating a decoding, key capable of decrypting the encrypted data file;
g) Maintaining the decoding key separately from the encrypted data file such that the source of the decoding key has no knowledge of which decoding keys are associated with which encrypted data files; and
h) A means for embedding specific URL's on the third-party platform to connect the decoding key and the encrypted file.

10. A system for embedding source information on a third-party platform that allows for 2-D image sharing comprising:
a) Creating an encrypted data file capable of being uploaded to a third-party platform and capable of undergoing loss compensation on the third-party platform;
b) Creating a decoding key capable of decrypting the encrypted data file;
c) Maintaining the decoding key separately from the encrypted data file such that the source of the decoding key has no knowledge of which decoding keys are associated with which encrypted data files; and
d) A means for overlaying decoding key access controls to the encrypted data file though the third-party platform's existing application program interface.
